(19) United States
(12) Patent Application Publication
(10) Pub. No.: US 2003/0047505 A1
(43) Pub. Date: Mar. 13, 2003

(54) Tubular filter with branched nanoporous membrane integrated with a support and method of producing same

(76) Inventors: Craig A. Grimes, Boalsburg, PA (US); Dawei Gong, State College, PA (US)

Correspondence Address: JEAN M. MACHELEDT, 501 SKYSAIL LANE, SUITE B100, FORT COLLINS, CO, 80525-3133, US

(21) Appl. No.: 10/243,303

(22) Filed: Sep. 13, 2002

Related U.S. Application Data
(60) Provisional application No. 60/318,926, filed on Sep. 13, 2001.

(51) Int. Cl. B01D 69/04; B01D 69/10; B01D 71/02

(52) U.S. Cl. 210/483; 210/488; 210/490; 210/500.1; 210/321.78

(57) ABSTRACT

A nanoporous tubular filter having a membrane comprising a network of generally branched pores formed by anodization of a section of metal tubing. The network extends from an inner wall of the filter to and through an outer exposed wall area of the membrane, and has a first layer of pores with a diameter greater than that of pores of an adjacent second layer. Further, the network is integral with an outer support matrix having been formed of an outer wall of the section of tubing by removing selected portions of the outer wall, thus leaving the exposed wall area of the membrane. The outer support matrix corresponds with a patterned area formed of an external-coat applied to the tubing's outer wall. An electroplating of a magnetostrictive material deposited on the outer support matrix or on an interior surface is adapted for use as a diffusion ON-OFF switch. The filter is adaptable for use as a hydrogen reactor whereby an electroplating of a catalyst material is deposited on at least a portion of the filter's inner wall. Also, a method for producing a nanoporous tubular filter that includes the steps of: applying an external-coat to an exterior surface of an outer wall of a section of metal tubing; anodizing the section of tubing at a first voltage for a first time-period then at a second voltage for a second time-period, a membrane produced thereby comprising a network of generally branched pores; and forming a patterned area to cover that portion of the outer wall that will form an outer support matrix.

This application claims priority to pending U.S. provisional patent application serial No. 60/318,926 filed on behalf of the assignee hereof on Sep. 13 2001.

### BACKGROUND OF THE INVENTION

### FIELD OF THE INVENTION

In general, the present invention relates to techniques for producing nanoporous membranes utilizing anodization to create a pore structure for specialized applications. More-particularly, the invention is directed to a nanoporous tubular filter and associated method for producing a tubular filter having a membrane of generally branched pores formed by anodization of a section of metal tubing, integral with an outer support matrix conveniently formed out of an outer wall of the section of tubing. The filter is preferably produced from a section of metal tubing. While the nanoporous filter of the invention is targeted for biofiltration and gas separation, such as for controlling molecular transport in immunoisolation applications, it can accommodate a wide variety of filtration uses. For example, where a diffusion rate of a particular component of a mixture is specified and filtration of another molecule within the mixture is desired, the porous membrane is comprised of at least two ‘layers’ of branched pores, one layer having pores sized to allow the smaller molecules to diffuse at the specified rate with the other layer having smaller-sized pores impermeable to the molecule selected for filtration. The layer thickness and pore size of the membrane is controlled during the anodization of the section of metal tubing.

Where traditional fabrication and use of anodized multi-layer porous membranes has been limited to planar structures with pore size ranging greater than 40 nanometers, those that are fabricated with a pore size less than 40 nanometers using conventional techniques create very fragile brittle porous structures that are difficult to handle without breakage. Thus, conventional filter fab techniques fall short when trying to fabricate a filter having small sized pores. The unique nanoporous filter of the invention is a tubular filter structure having both a branched porous membrane and an integral outer support matrix made from that portion of the section of metal tubing generally left un-anodized. This branched network includes a layer of larger-sized pores and a thinner layer of smaller sized pores (≦40 nanometers) impermeable to those molecules the filter has been designed to keep-out, or filter/trap. For example, a tubular filter produced according to the invention may be permanently capped at each end to create small capsules through which a selected nutrient or therapeutic drug may pass, yet impermeable to undesirable immunological molecules outside the capsule.

While the focus of the invention is on anodizing sections of aluminum or titanium tubing, other metals and alloys capable of transformation into a generally branched multi-layer porous network may be used to the extent an outer support matrix can be integrated therewith for additional structural integrity according to the invention. One key feature of the invention is that the layer of the membrane having the smaller-sized pores, ranging from 5 to 40 nanometers, need not be very thick, allowing the layer(s) of larger-sized pores—ranging anywhere from 30 to 200 nanometers depending upon factors such as the specific filtration application, size distribution of the molecule(s) that will pass through the membrane, and desired rate of diffusion—to make up a larger portion of membrane wall thickness, thus providing better structural integrity. The integration of an outer support matrix fabricated from an outer wall of tubing material provides further mechanical strength for handling and use in a multitude of environments including those considered caustic, as well as pressurized, aqueous or other liquid, or gas environments.

General technical background reference—Anodization: The anodization of aluminum and other metals is a well known process. Distinguishable from the instant invention, is Furneaux, et al. (U.S. Pat. No. 4,687,551)—its technical discussion incorporated herein by reference—which details a process to anodize an aluminum sheeting substrate at different applied voltages, incrementally reduced in small steps down to a level preferably below 3 V. The Furneaux, et al. process results in a very fragile planar alumina film—undesirable in the case of the instant invention. Nevertheless, the anodizing process of Furneaux, et al. has characteristics that may be used to create a membrane according to the instant invention. Several paragraphs of Furneaux, et al.'s technical discussion concerning the anodizing of aluminum—col. 1, lines 5-25; col. 4, lines 23-end; col. 5, lines 1-24 and lines 52-65; and col. 6, lines 43-52—have been reproduced below:

When an aluminum [sic] metal substrate is anodized in an electrolyte such as sulphuric acid or phosphoric acid, an anodic oxide film is formed on the surface. This film has a relatively thick porous layer comprising regularly spaced pores extending from the outer surface in towards the metal; and a relatively thin non-porous barrier layer adjacent the metal/oxide interface. As anodizing continues, metal is converted to oxide at the metal/oxide interface, and the pores extend further into the film, so that the thickness of the barrier layer remains constant. The cross-section and spacing of the pores and the thickness of the barrier layer are all proportional to the anodizing voltage.

It is possible to separate the anodic oxide film from the metal substrate by etching away the metal substrate. If the barrier layer is also then removed by dissolution in acid or alkali [sic], there remains a porous anodic aluminum oxide film. Such films are useful as filters for example for desalination of salt water, dewatering of whey or for dialysis. Other uses include bacterial filters for cold sterilization, and gas cleaning.

When an aluminum [sic] metal surface is anodized using a range of electrolytes, a porous anodic oxide film is formed. This comprises a non-porous barrier layer adjacent the metal, whose thickness is approximately 1 nm per volt. The pores have a diameter of approximately 1 nm per volt and are spaced apart approximately 2.5 nm per volt, these figures being largely independent of electrolyte, temperature and whether AC or DC is used. A voltage reduction is followed by a temporary recovery phase, during which the barrier layer is thinned by the formation of new pores branching out from the bases of the old ones. When the barrier layer has reached a thinner value appropriate to the new voltage, recovery is complete, and anodizing continues by oxidation at the metal/alumina interface.

Successive voltage reductions lead to successive branching of the pores at their bottom ends. By terminating the voltage reduction at a very low voltage, only an extremely thin barrier layer is left which is readily dissolved causing separation of the film from the metal substrate.

The starting aluminum [sic] metal substrate is preferably high purity aluminum [sic] sheet, for example 99.9% or even 99.99% aluminum. Metal foil could be used, but sheet is preferred because it ensures the absence of pin-holes. Lower purity aluminum [sic] could be used, but may contain inclusions that affect formation of the desired network of pores where a very fine network is desired. The metal surface may be prepared by chemical polishing, but any other method of providing a smooth surface, e.g. caustic etching, is satisfactory. Ordinary bright rolled sheet may be used. The metal surface is cleaned and degreased and is then ready for anodizing.

Anodizing conditions are not critical. Direct current is preferably used, but alternating, pulsed or biased current may be used. An electrolyte is used that gives rise to a porous anodic oxide film, sulphuric, phosphoric, chromic and oxalic acids and mixtures and these being suitable. Although electrolytes are generally acid, it is known to be possible to use alkaline electrolytes such as borax, or even molten salt electrolytes. It is believed to be the simultaneous dissolution/film formation mechanism that gives rise to porous films, and this mechanism can operate in an acid or alkaline environment. Anodic oxide films generally contain a proportion, sometimes a substantial proportion up to 15 % or more, of anion derived from the anodizing electrolyte.

The applied voltage is raised from zero to a level designed to achieve a desired pore diameter and pore spacing (as discussed in more detail below) and continued for a time to achieve a desired film thickness. For example, using a 0.4 M orthophosphoric acid electrolyte at 25 to 30 degree-C. at a current density of 1.5 A/dm.sup.2 a voltage of 150 to 160 volts needs to be applied for around 100 to 120 minutes to achieve a film thickness of 40 to 60 microns.

The anodizing voltage may be chosen to achieve the desired pore spacing. For wide pore spacings high voltages may be used, and we ourselves have used up to 700 V. But at these levels it is necessary to use dilute electrolyte, (e.g. 0.01% oxalic or phosphoric acid), because the use of electrolyte of conventional concentration (e.g. 0.4 M phosphoric acid) results in dielectric breakdown of the film which prevents further anodizing.

The voltage reduction procedure may be carried out in the same electrolyte as that used for anodizing. Alternatively, the electrolyte may be changed either before or during the voltage reduction procedure. Since separation of the film from the substrate depends on chemical and field-assisted chemical dissolution of film material, the electrolyte should be chosen to be effective for this purpose. Sulphuric acid and oxalic acid have been successfully used. However, phosphoric acid is preferred for the voltage reduction procedure, particularly the final stages, for two reasons. First, since phosphoric acid exerts a rather powerful solvent effect on alumina, recovery of the anodic film tends to be faster as the voltage is reduced. Second, phosphate inhibits hydration of alumina, which might otherwise occur, either during or more likely after the voltage reduction procedure, with swelling and loss of control over pore size. Where hydration of alumina is desired, e.g. in order to further reduce the pore size, the use of phosphoric acid should be avoided.

The voltage reduction step may be performed using continuous or pulsed DC, or alternatively AC with the extent of cathodic polarization of the metal substrate being limited such that gas evolution does not significantly take place thereon during the cathodic part of the cycle. A biased AC waveform is also contemplated and may be advantageous.

Sufficient time is allowed between incremental voltage reductions for partial or complete recovery of the film. It is envisaged that recovery involves penetration of the barrier layer by new pores of a size and spacing appropriate to the reduced voltage, and it is necessary to the method that new pore formation should take place as the voltage is reduced.

Factors which affect film recovery time and time for separation of the film from the metal substrate include the nature, the concentration, and the temperature of the electrolyte. Faster times are achieved by using electrolytes having greater dissolving power for alumina; higher concentrations of electrolyte; and higher electrolyte temperatures. It will generally, though not always, be desired to achieve fast times, so as to minimize [sic] the inevitable chemical dissolution of the anodic oxide film which takes place all the time [end].

Need for a New Filter: Although porous polymer films do exist, and a micromachined semipermeable membrane and an anodized planar aluminum oxide (AAO) film having a high pore density throughout (˜10¹⁰/cm²) have been used for biofiltration applications, none of the existing porous films serves as a long term solution for in vivo use, such as immunoisolation, therapeutic drug delivery using the devices contemplated hereby: biocapsules, bioreactors, and biofiltration devices. Although planar AAO structures have been used in microscopy and liquid chromatography, these structures as designed are not suitable for use where containment and measurable passive diffusion of a substance such as a drug or nutrient is desired while at the same time filtration is necessary of unwanted substances/components without intervention. As one will appreciate, distinguishable from conventional membrane structures is the nanoporous tubular filter, and associated method for producing such a filter according to the invention.

### SUMMARY OF THE INVENTION

It is a primary object of this invention to provide a metallic nanoporous tubular filter and method for producing such a filter having diffusion and filtration capabilities for selected substances/molecules, components of a mixture (liquid or gas), and so on, while having sufficient structural integrity to be incorporated as the body of a containment structure, such as a capsule or filtration subassembly (e.g., conduit of a filtration system or of a bioreactor system), for various applications.

Advantages of providing the new filter and associated method for producing include any expressly identified herein as well as the following, without limitation:

(a) Dual-mode operability—The invention provides a sturdy, or reinforced, multi-layer branched porous tubular platform which can be used to both allow diffusion of a selected substance (e.g., insulin or other therapeutic drug, nutrients, hydrogen gas) while remain impermeable to a target molecule of a larger size (e.g., an antibody, pathogen or other molecule which, if mixed with the substance contained within the tubular structure would destroy or otherwise degrade its effectiveness).

(b) Flexibility of design and use—A nanoporous membrane structure produced according to the invention can be tailored for use to filter a wide variety of target molecules while allowing selected substances to pass through the membrane. The many design parameters offered according to the invention (anodization parameters such as pore size distribution and porous layer(s) thickness; total surface area and patterning of exposed wall area of the membrane through which the substances pass; thickness, surface area, and shape/pattern of the outer support matrix surrounding the membrane, a magnetostrictive electroplate ON-OFF switch feature, catalyst reaction plating, and so on) provide several options for tailoring a filer of the invention to a specific application. The tubular filter structures produced according to the invention—regardless of final cross-section shape (circular, oval, polygon, irregular)—have sufficient structural integrity for use in fabrication of capsules or other small filtration receptacles, conduit in a filtration system, and so on, where planar filter structures are unsuitable.

(c) Manufacturability—The unique multi-step method of producing a filter of the invention can be tailored to reproduce/fabricate filters on a wide scale allowing for assembly line production in an economically feasible manner.

Briefly described, once again, the invention includes a nanoporous tubular filter having a membrane comprising a network of generally branched pores formed by anodization of a section of metal tubing. This network extends from an inner wall of the filter to and through an outer exposed wall area of the membrane, and has a first layer of pores with a diameter greater than that of pores of an adjacent second layer. Further, the network is integral with an outer support matrix having been formed of an outer wall of the section of tubing by removing selected portions of the outer wall, thus leaving the exposed wall area of the membrane. The outer support matrix corresponds with a patterned area formed of an external-coat applied to the tubing's outer wall. The external-coat from which the patterned area is formed, may be an initial external-coat applied to an exterior surface of the outer wall prior to anodization of the section of tubing producing the network of pores, or may be a second external-coat applied by stenciling or other suitable fashion after the initial external-coat has been removed (once the network has been formed). For example, the patterned area may comprise residual portions of the external-coat left after removal of surrounding material by way of subtractive etching, scratching-off, etc. Where the anodization is performed using a first and second voltage, the pores of the first layer are formed during the time the first voltage is applied and the second layer pores are formed during the time the second voltage is applied. The first voltage may be selected from a first range of values (for example, 25V to 100V) and the second voltage selected from a second range of values (for example, 5V to 25V). If the first voltage is greater than the second voltage, the pores of the first layer will have a size distribution/diameter greater than the size distribution/ diameter of the second layer of pores. In the event an initial external-coat is applied to ‘protect’ the exterior surface of the outer wall from being anodized while the membrane is being formed, the network will be formed from the inner wall of the section of tubing, outwardly. Where the first voltage is applied prior to the second voltage to form the network of pores, the first layer is internal with respect to the second layer.

In another aspect of the invention, the focus is on a method for producing a nanoporous tubular filter. The method includes the steps of: applying an external-coat to an exterior surface of an outer wall of a section of metal tubing; anodizing the section of tubing at a first voltage for a first time-period then at a second voltage for a second time-period, a membrane produced thereby comprising a network of generally branched pores extending from an inner wall of the section of tubing to and through an exposed wall area of the membrane; and forming a patterned area to cover that portion of the outer wall that will form an outer support matrix. The network formed has a first layer of pores with a size different than that of pores of an adjacent second layer. The step of removing portions of the outer wall around the patterned area to create the exposed wall area of the membrane, can be performed by suitable means such as placing the section of tubing into an acid mixture. Once the outer support matrix has been formed, the patterned area may be removed to expose the outer support matrix.

There are many further distinguishing features of producing a filter according to the invention, as follows. The step of forming a patterned area may be performed by: removing surrounding material of the external-coat, leaving the patterned area to comprise residual portions of the external-coat; or by removing an initial external-coat once said membrane has been formed, then stenciling a second external-coat to the outer wall to form the patterned area. Prior to the step of applying an initial external-coat, one can anodize the section of tubing to form a thin porous alumina layer on an exterior surface of the outer wall—thus, aiding in adhesion of the external-coat thereto. After the step of applying an initial external-coat, a nano-sized array of pores may be created, functioning as a platform or foundation from which the first layer of pores is constructed: first, the section of tubing is anodized creating an initial alumina (or other suitable material) film on an interior surface of the inner wall, then a substantial portion of this initial alumina film is removed by suitable means such as placing the section of tubing into an acid mixture. By way of example, the pores of this initial alumina film can be created by applying a voltage selected from an initial range of 25V to 100V, to create a film preferably having a thickness from approximately 5 to 200 microns and pores with a diameter generally equal to the size of the first layer pores. Once the membrane has been formed, the patterned area is formed (a) from the external-coat (for example, by etching selected portions thereof—leaving the desired pattern in-tact) or (b) by first removing the whole of an initial external-coat and then stenciling on a second external-coat in the form of the desired patterned area. Prior to forming the outer support matrix, it may be desirable to temporarily cap each of an end of the section of tubing with a polymer or other suitable material, to seal off the inner wall from exposure to an agent used during the step of forming the outer support matrix so that the membrane's network of pores is not degraded or destroyed while forming the outer support matrix. The step of applying an external-coat may be carried out by adhering a coating of polymer or other suitable protective coat material which can be partially or completely removed from the exterior surface to form the patterned area used to aid in formation of the outer support matrix.

Further additional distinguishable features of the filter structure and its method of production according to the invention, follow: The membrane may be made of alumina A1₂O₃ (a ceramic), a by-product of anodizing a section of aluminum tubing, or—depending upon tubing material—will be made of some other by-product of anodizing the section of tubing. In the case where aluminum tubing is used, the outer support matrix will comprise aluminum. The exposed wall area may be comprised of any of a multitude of suitable patterning shapes, preferably producing a sufficiently strong filter structure for an intended application, such as a window-pattern, a spiral, striping, a zig-zag pattern, a plurality of alternating rings, and an irregular design. In the event a cap is permanently secured at each end of the tubular filter, a capsule is formed adaptable to contain a substance permeable to the membrane; by sizing the second layer of pores of the membrane smaller than the size of a selected molecule type, the membrane will be made impermeable to those molecules. The filter may be further adapted for in vivo use whereby the substance is a nutrient and the selected molecule type comprises an immunological molecule. An electroplating of a magnetostrictive material deposited on exposed areas of the outer support matrix or on an interior surface of the tubing provides a diffusion ON-OFF switch for the filter. Application of a time-varying magnetic field to a filter structure vibrates the electroplating which, in turn, alters the rate of diffusion of a selected substance through the membrane. For example, a vibrating filter can be tuned to turn the filter OFF where a passive filter is ON. The filter is adaptable for use as a hydrogen reactor whereby an electroplating of a catalyst material, such as platinum, is deposited on at least a portion of the filter's inner wall. The cross-section of the inner wall of the filter need not only be circular, but might have an inner surface perimeter of a different shape such as an oval, a polygon, or an irregular shape. Other structural features of a filter targeted for use in in vivo biofiltration applications, include: the membrane may have a thickness of approximately 100 microns; diameter of the first layer of pores preferably ranges from about 40 to 200 nanometers (depends upon the substance which will diffuse through the membrane); a thickness of the second layer pores is less than 15 microns and the diameter of these pores can range from 5 to 40 nanometers (depends upon the size of the molecules targeted to remain outside of the tubular filter because they are unable to permeate the membrane).

### BRIEF DESCRIPTION OF THE DRAWINGS

For purposes of illustrating the innovative nature plus the flexibility of design and versatility of the preferred nanoporous filter structures and method of producing disclosed hereby, the invention will be better appreciated by reviewing the accompanying drawings (in which like numerals, if included, designate like parts). One can appreciate the many features that distinguish the instant invention from known porous structures. The drawings have been included to communicate the features of the innovative design, structure, and associated technique of the invention by way of example, only, and are in no way intended to unduly limit the disclosure hereof.

FIGS. 1A-1F depict a nanoporous filter structure at various stages of fabrication, cross-sectional views respectively labeled 10a-10f, according to the invention.

FIGS. 2A-2B are isometric views of a tubular filter structure of the invention: without an external-coat (FIG. 2A) and with an external-coat 37 (FIG. 2B).

FIGS. 3A-3B are, respectively, top-view and side-view cross-sectional Field Emission Scanning Electron Micrograph (FE-SEM) images of one layer of the network of pores of a membrane component (such as those schematically depicted at 18c-18f, FIGS. 1C-1F) of a filter structure of the invention. FIG. 3C is a graphical representation of pore size distribution of the network illustrated in FIGS. 3A-3B.

FIG. 4 graphically depicts normalized release curves of a substance, here, fluorescein (size ˜400 Da), diffusing through the exposed membrane area (e.g., windows) of capsules made from tubular filter structures fabricated according to the invention. As labeled on the curves, each capsule's membrane has one layer of pores sized at 55 nanometers, 40 nanometers, and 25 nanometers.

FIG. 5 graphically depicts normalized release curves of a substance, here, fluorescein and FITC-dextran conjugate molecules (sized ˜4000 Da, 20,000 Da and 70,000 Da), diffusing through the exposed membrane area (e.g., windows) of capsules made from tubular filter structures fabricated according to the invention. As labeled, the capsule's membrane has one membrane layer of pores sized at 55 nanometers.

FIG. 6 is a Scanning Electron Micrograph (SEM) cross-sectional image of a membrane component of a filter structure of the invention, depicting the membrane's network of generally branched pores having been produced during anodization of a section of aluminum tubing at two different voltages.

FIG. 7 is a flow diagram depicting details of a method 70 for producing nanoporous filter structures—illustrated are core, as well as further distinguishing, features of the invention for producing structures such as those represented and depicted in FIGS. 1A-1F, 2A-2b,3A-3B, and 6.

FIGS. 8A-8D depict a nanoporous filter structure at various stages of fabrication, cross-sectional views respectively labeled 80a-80d, to which an electroplating 83e of FIG. 8D is deposited at selected areas of exposed metal on the interior surface of the tubing inner wall, according to the invention.

FIGS. 9A-9B depict a nanoporous filter structure, cross-sectional views respectively labeled 90a and 90b to which an electroplating 93e-a and 93e-b is deposited—in FIG. 9A throughout the interior surface of the tubing wall, and in FIG. 9B at selected areas of exposed metal on the support matrix, according to the invention.

FIG. 10 is a flow diagram depicting details of a method 100 for producing nanoporous filter structures—including core, as well as further distinguishing features for producing structures such as those depicted in FIGS. 8A-8D and 9A.

FIG. 11 is a flow diagram depicting details of a method 110 for producing nanoporous filter structures—including core, as well as further distinguishing features for producing structures such as those depicted in FIG. 9B.

### DETAILED DESCRIPTION OF THE EMBODIMENTS DEPICTED IN THE DRAWINGS

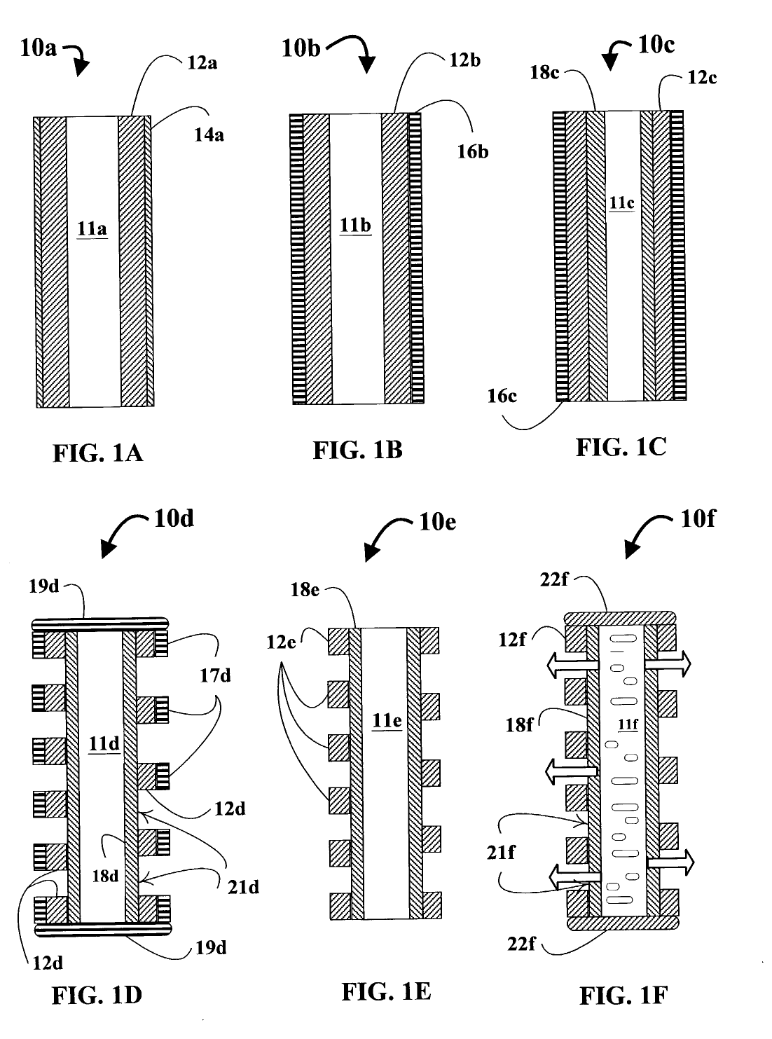

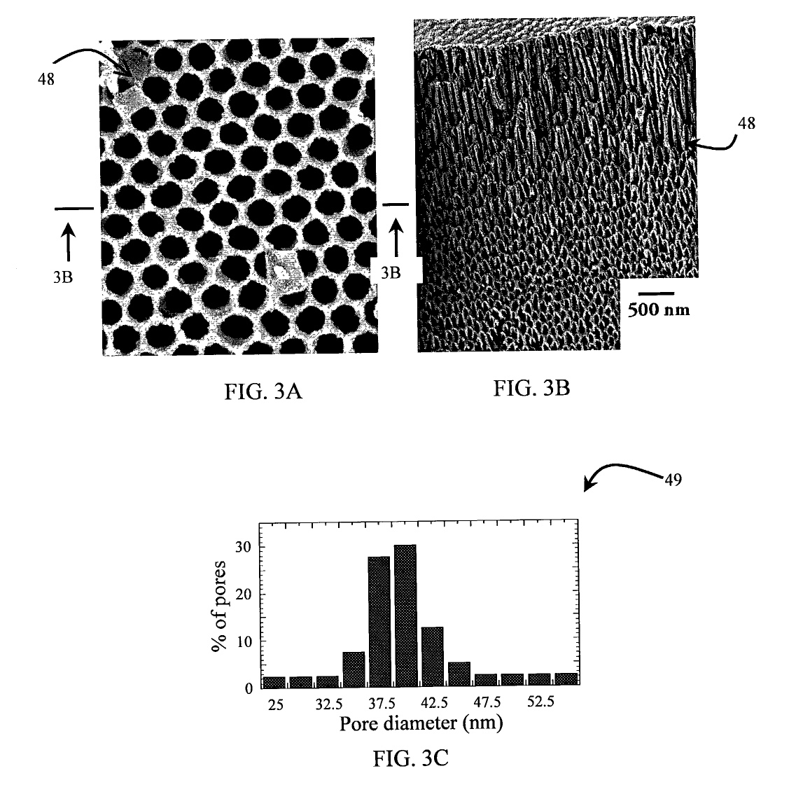

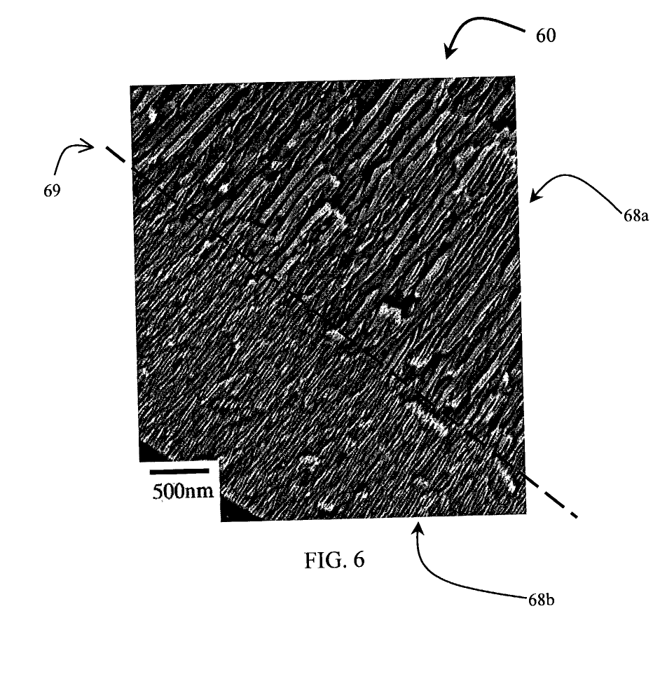

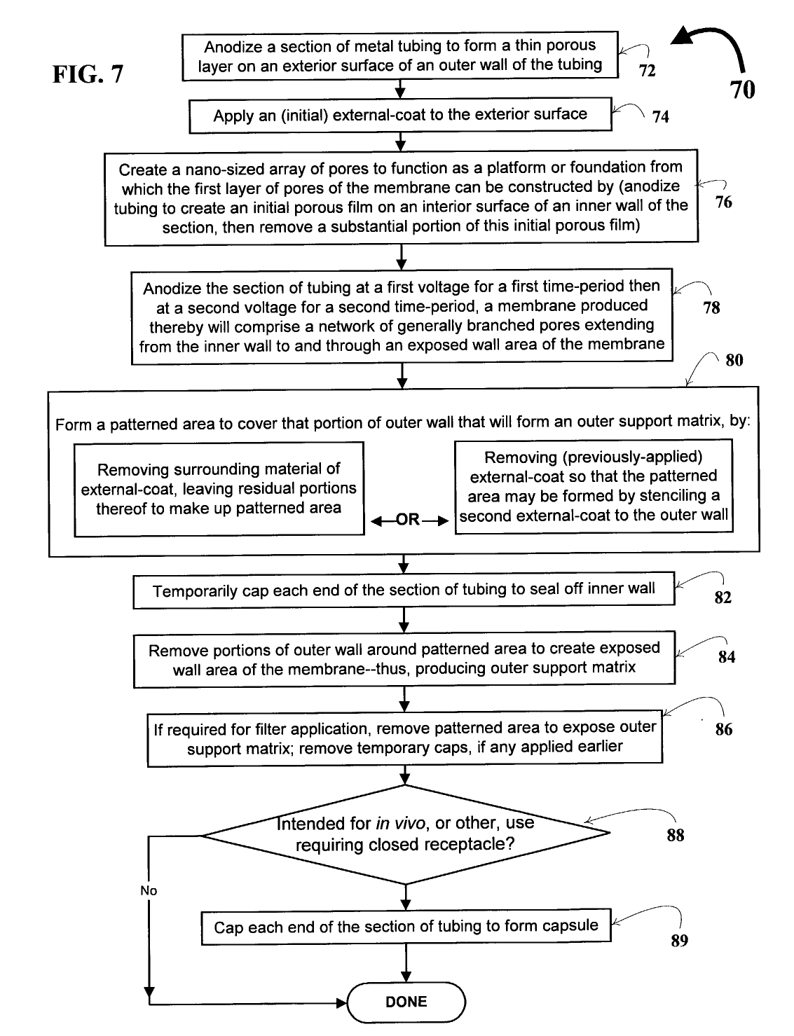

FIGS. 1A-1F depicts a nanoporous filter structure at various stages of fabrication, cross-sectional views respectively labeled 10a-10f, according to the invention. Referring, next, to FIGS. 1A-1F in connection with FIG. 7 (detailing features of a method 70 for producing the filters in flow-diagram format) as well as FIG. 6, one can better appreciate the features of the filter structures depicted in FIGS. 3A-3B. A section of metal tubing 12a can first be anodized to form a thin porous film 14a on the exterior surface of the outer wall of metal to aid in adhesion of an external-coat 16b (step 72). By way of example, this very first anodization may be done using an electrolyte such as oxalic acid for several minutes to form a thin layer, less than 100 nanometers, of alumina on the exterior surface of the tubing. The section of tubing in FIG. 1B, has an external-coat 16b of a material selected for its ability to provide a ‘protective’ layer applied to the external surface (step 74) so that the anodizing done to produce the membrane structure does not destroy or otherwise cause too much damage to the outer wall (from which the filter outer support matrix is later formed). Preferably, the outer wall's mechanical integrity is generally maintained throughout the process of producing the network of pores of the membrane (18c-f), so that the outer wall (12c) can be employed to form an effective support matrix (12d-f) for the filter.

The membrane 18c-f, comprising a network of generally branched pores is formed next—for reference, a two-layer network produced by anodizing aluminum is detailed in FIG. 6 at 60 and an enlargement of one of the layers (here, alumina) of a network of pores is shown at 48 in the top and sectional views, respectively labeled FIGS. 3A-3B. Preferably, the porous network is produced from the inside wall (channel 11c) out, in a manner that creates a layer of larger-sized pores (68a in FIG. 6) on the inside and the thinner layer of smaller-sized pores (68a in FIG. 6) exposed at area 21d/f. As will be explained in further detail in connection with FIGS. 3A-3B and FIG. 6, the anodization of tubing 12a occurs using a unique two-step process (steps 76 and 78 of FIG. 7), the later of which preferably takes place by applying two different voltages, each of which produces a different sized porous structure—see earlier general technical discussion regarding anodizing at two voltages.

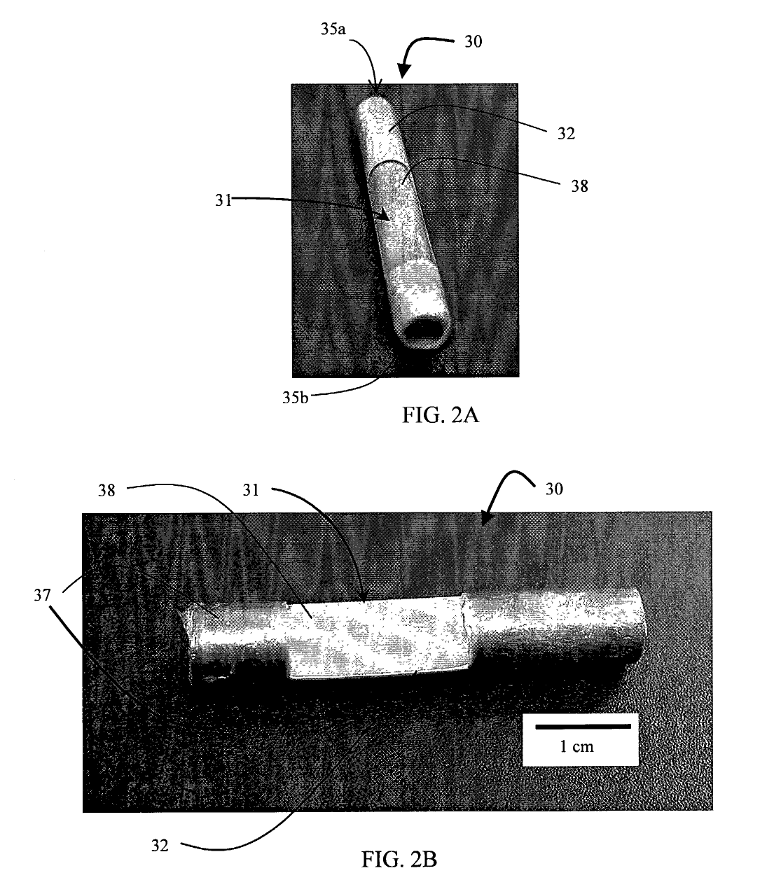

Next (step 80), a patterned area 17d is formed to cover that portion of the outer wall that will form an outer support matrix 12d-f. Optionally, the external-coat applied earlier and labeled 16b-c (FIGS. 1B-1C) may be used to form patterned area 17d by removing, using conventional suitable techniques, the surrounding material of coat 12d-f, leaving residual portions thereof to make up the patterned area 17d. Alternatively, external-coat 16b-c can be completely removed using conventional etching techniques (mechanical or chemical—such as by dipping structure 10c in a caustic agent) and then applying the patterned area as a second external-coat by way of stenciling, spraying, sputtering, into the patterned shape. Once the patterned area is formed, it serves (along with a temporary capping at 19d of the structure ends-step 82—using a suitable polymeric material, for example) as a protective coat during the process (step 84) to remove those portions of outer wall 12c around the patterned area 17d in order to create an exposed wall area (at 21d, 21f of FIGS. 1D, 1F and 31 of FIGS. 2A-2B) of the membrane through which molecules can pass. For many applications using the filters of the invention, it is preferred that the external-coat (patterned areas 17d as well as temporary caps 19d) be removed (step 86) so as not to contaminate the environment in which the filter is used (e.g., where a capsule is desired—steps 88 and 89—or tubular filtration is used in vivo as a drug delivery device or biofluid regulation device). This may be accomplished by any suitable means, such as dipping the structure 10d into a bath of a caustic agent selected so that it does not cause degradation of the outer support matrix 12d-f or membrane 18d-f.

By way of example, FIG. 1F includes a cap 22f at each of the ends of the structure 10f to encapsulate a selected substance within the receptacle formed 11f. Arrows have been included in FIG. 1F representing the general flow of the substance within 11f, outwardly through membrane 18f and out window patterned exposed area 21f. As will be better appreciated in connection with the following example, pore size and porous layer thicknesses, as well as surface area of the exposed wall, are selected to meet identified diffusion parameters (e.g., rate of diffusion of contents of 11f through the membrane 18f), depending upon the specific application. As mentioned, the exposed wall area may be comprised of any of a multitude of suitable patterning shapes, preferably selected such that a sufficiently strong filter structure is produced for an intended application, such as a window-pattern, a spiral, striping, a zig-zag pattern, a plurality of alternating rings, and an irregular design.

FIGS. 2A-2B are isometric views of tubular filter structure 30 of the invention. In FIG. 2A the structure's ends have been labeled for reference as 35a, 35b; and since no coat has been applied to the structure 30 of FIG. 2A, the exterior of outer support matrix 32 is plainly visible. In both FIGS. 2A and 2B the exposed wall area of the membrane 38 can be seen through window 31. However, in FIG. 2B the exposed window area 31 provides a sectional view of the outer support matrix 32 to which an exterior-coat 37 has been applied. Although fabricated to have a circular cross-section, the structures of the invention may have inner walls of a variety of shapes: circular as shown, oval, polygonal, and any suitable irregular shape. By way of example, capsules or filtration devices made from tubular structures of the invention can range in size from 1 mm to 200 meters in length, with suitable interior volumes according to use.

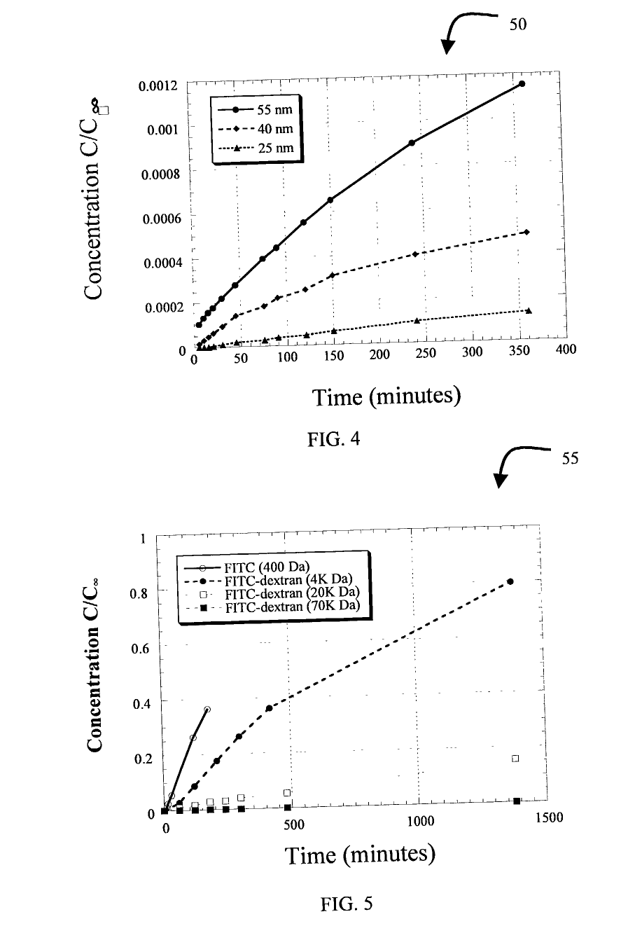

FIGS. 3A-3B are, respectively, top-view and side-view Field Emission Scanning Electron Micrograph (FE-SEM) cross-sectional images taken along 3B-3B, of one layer of a network of pores of a membrane component of a filter structure of the invention. By way of example here, the porous structure 48 was created using a unique two-step process (steps 76 and 78 of FIG. 7), the later process having taken place by applying a single voltage (30 V, by way of example only, in 0.2 M oxalic acid) producing a porous network having a pore size distribution graphically represented at 49 in FIG. 3C. Although, anodization to produce the membrane (step 78) preferably takes place by applying two different voltages (a different sized porous structure produced with each different voltage applied to create a generally branched network such as that at 60 in FIG. 6), filters produced with a single layer (such as that depicted in FIGS. 3A-3B) were fabricated and used to record diffusion curves illustrated in FIGS. 4 and 5.

FIG. 4 graphically depicts normalized release curves of a substance, here, fluorescein (size ˜400 Da), diffusing through the exposed membrane area (e.g., windows) of capsules made from tubular filter structures fabricated according to the invention. Here, simply to illustrate an example of drug release characteristics of capsule of the invention, each capsule's membrane (for which data was collected and reported) has one layer of pores sized at 55 nanometers, 40 nanometers, and 25 nanometers. The release rates are graphically illustrated, here, as C/C_{∞} (along the y-axis) vs. time (along the x-axis) where C represents molecule concentration in the media at time t and C_{∞} represents the concentration in the media at infinite (∞) time, i.e. the time at which it's presumed the capsule will have released its entire contents.

FIG. 5 graphically depicts normalized release curves of a substance, here, fluorescein and FITC-dextran conjugate molecules (sized ˜4000 Da, 20,000 Da and 70,000 Da), diffusing through the exposed membrane area (e.g., windows) of capsules made from tubular filter structures fabricated according to the invention. The capsule's membrane (for which data was collected and reported, by way of example only) has one membrane layer of pores sized at 55 nanometers. Once again, release rates are graphically illustrated by way of example, as C/C_{∞} (along the y-axis) vs. time (along the x-axis) where C represents molecule concentration in the media at time t and C_{∞} represents the concentration in the media at infinite (∞) time, i.e. the time at which it's presumed the capsule will have released its entire contents.

FIG. 6 is a Scanning Electron Micrograph (SEM) cross-sectional image of a membrane component of a filter structure of the invention, depicting the membrane's network of generally branched pores producing a two-layered network (for reference, a dashed-line 69 generally separates the two layers) having been produced during anodization of a section of aluminum tubing at two different voltages. By way of example only, here, the larger sized pores may be fabricated at an anodizing voltage of 40 V (the ‘layer’ labeled 68a) and the smaller pores (the ‘layer’ labeled 68b) may be produced at an anodizing voltage of 20 V.

FIG. 7 is a flow diagram depicting details of a method for producing nanoporous filter structures. Illustrated at 70 are core, as well as further distinguishing, features of the invention for producing structures such as those represented and depicted in FIGS. 1A-1F, 2A-2b, 3A-3B, and 6. Reference and discussion has been made throughout this disclosure of the novel steps of method 70, in connection with other figures.

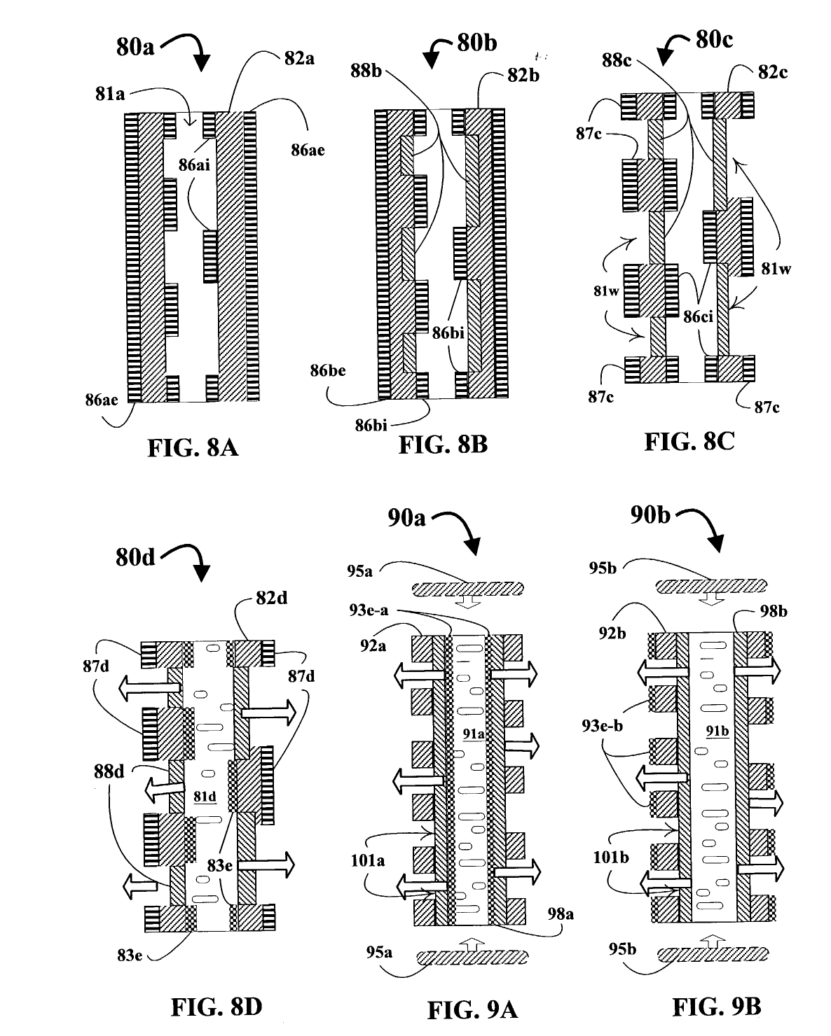

FIGS. 8A-8D depict a nanoporous filter structure at various stages of fabrication, cross-sectional views respectively labeled 80a-80d, to which an electroplating 83e of FIG. 8D is deposited at selected areas of exposed metal on the interior surface of the tubing inner wall, according to the invention. FIGS. 9A-9B depict a nanoporous filter structure, cross-sectional views respectively labeled 90a and 90b to which an electroplating 93e-a and 93e-b is deposited—in FIG. 9A throughout the interior surface of the tubing wall, and in FIG. 9B at selected areas of exposed metal on the support matrix, according to the invention.

Turning to FIGS. 8A-8D in connection with FIG. 100 (detailing features of a method 100 for producing a filter to which an electroplating has been deposited): An external-coat (86ae, 86be) and internal-coat (86ai, 86bi, 86ci) of a material selected for its ability to provide a ‘protective’ layer is applied, respectively, to the external surface (step 174) and interior surface (step 172) so that the anodizing done to produce the membrane structure does not further anodize or cause damage to the tubing—thus, preserving, beneath the external-coat, a metallic outer wall (from which the filter outer support matrix is later formed, step 182) and preserving, beneath the internal-coat, a metallic inner wall area (to which an electroplating is later deposited, step 184). Preferably, the outer wall's mechanical integrity is generally maintained throughout the process of producing the network of pores of the membrane (88b-d), so that the outer wall (82c) can be employed to form an effective support matrix (82c-d) for the filter.

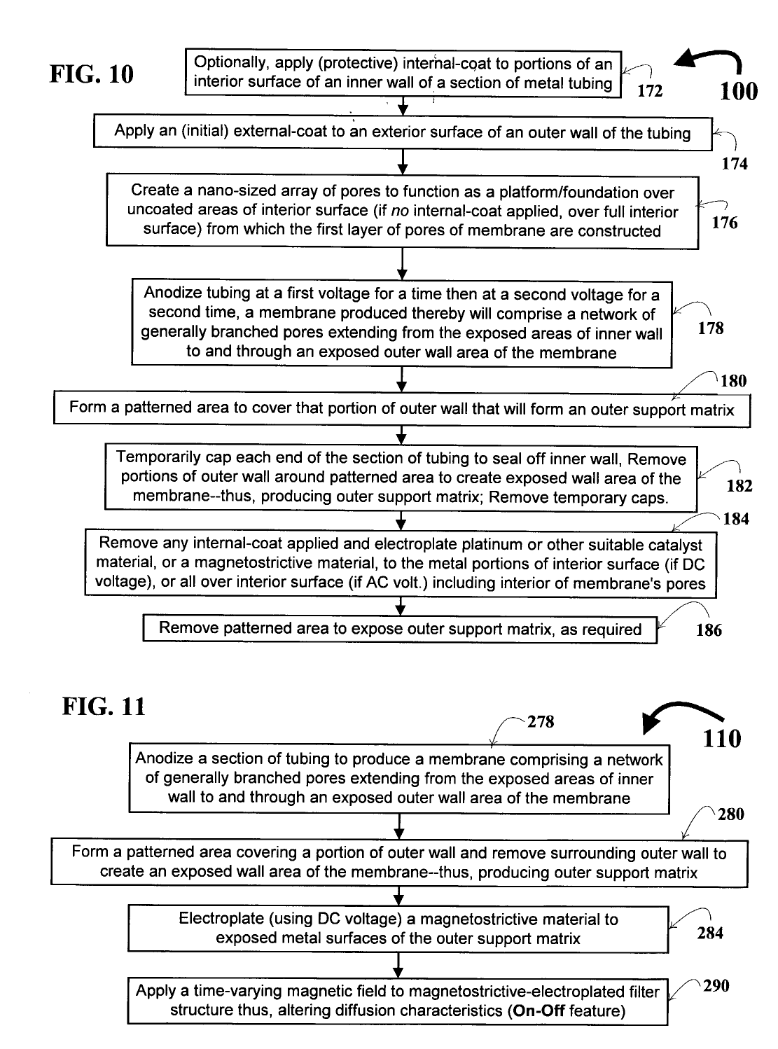

Once again, membrane 88b-d comprises a network of generally branched pores —for reference, a two-layer network produced by anodizing aluminum is detailed in FIG. 6 at 60 and an enlargement of one layer (here, alumina) of a network of pores is shown at 48 in the views, respectively labeled FIGS. 3A-3B; steps 178 and 278 in FIGS. 10 and 11. Preferably, the porous network is produced from the inside wall (channel 81d) out, in a manner that creates a layer of larger-sized pores (68a in FIG. 6) on the inside and the thinner layer of smaller-sized pores (68a in FIG. 6) exposed at area 81w (FIG. 8C).

Next (step 180, FIG. 10), a patterned area 87c-d is formed to cover that portion of the outer wall that will form an outer support matrix 82c-d. Optionally, the external-coat applied earlier and labeled 86ae-be (FIGS. 8A-8B) may be used to form patterned area 87c-d by removing, using conventional suitable techniques (for example, applying acetone to dissolve the polymer coat), the surrounding material of coat 86ae-be, leaving residual portions thereof to make up the patterned area 87c-d. Alternatively, external-coat 86ae-be can be completely removed using conventional etching techniques (mechanical or chemical—such as by dipping structure 80b in a caustic agent) and then applying the patterned area as a second external-coat by way of stenciling, spraying, sputtering, into the patterned shape. Once the patterned area is formed, it serves (along with a temporary capping if applied, such as that at 19d in FIG. 1D) at the ends—step 182—using a suitable polymeric material, for example) as a protective coat during the process (step 182) to remove those portions of outer wall 82b around the patterned area 87c-d in order to create an exposed wall area (at 81w of FIG. 8C) of the membrane through which molecules can pass. For many applications using the filters of the invention, it is preferred that the external-coat (patterned areas 87d as well as any temporary caps applied 19d) be removed (step 182) so as not to contaminate the environment in which the filter is used. This may be accomplished by any suitable means, such as dipping the structure 80d into a bath of a caustic agent selected so that it does not cause degradation of the outer support matrix 82d or membrane 88d. Likewise, internal-coat 86ci (FIG. 8C) is removed in order to expose metal (as the conductive cathode) to which an electroplating 83e can be deposited (step 184).

Turning to FIG. 9A and 9B illustrating electroplating 93e-a, 93e-b done to a structure similar to that shown at 10F, FIG. 1F—in the event needed for the particular application, caps 95a, 95b at each end of the structures 90a, 90b are shown in exploded view for reference. Each structure 90a, 90b has an interior 91a, 91b within which the substance is contained until diffused out through window areas 101a, 101b. In the case of FIG. 9A (step 184 points out that if AC voltage is used for the electroplating, material will be deposited over the entire surface including the inside of pore walls), electroplating 93e-a may be a suitable catalyst material such as platinum so that a desired reaction can take place within 91a. In the case of a hydrogen reactor, hydrogen is the substance that will diffuse through the membrane at window areas 101a. In FIG. 9B, electroplating has been done by depositing 93e-b the selected material onto exposed areas of the outer support matrix (step 284). When DC voltage is used to electroplate the material to a surface, the material will generally deposit only on conductive (e.g., metal or alloy cathode) surfaces—the ceramic membrane remaining generally un-plated.

Magnetic materials exhibit magnetic and elastic phenomena. Magnetic interaction depends on the distance of the interacting particles and consequently magnetic and mechanic effects interact. In ferromagnetic materials, magnetostriction is observed: The dimensions and elastic properties of magnetic materials often depend on the state of magnetization (direct magnetoelastic effect). Simply stated, “magnetostriction” is the phenomena whereby a material will change shape (dimensions) in the presence of an external magnetic field. Since the atoms in a magnetostrictive material are not, for all practical purposes, perfectly spherical (they're shaped more like tiny ellipsoids) the reordering of the dipoles causes an elongation (or contraction depending on the mode of reorientation) of the lattice which leads to a macroscopic shape change in the material. Known magnetostrictive materials include alloys of iron (Fe), cobalt (Co), samarium (Sm), yttrium (Y), gadolinium (Gd), terbium (TB), and dysprosium (Dy). There are many magnetostrictive materials currently available that may be used for electroplating surfaces of a filter structure of the invention.

When a sample of magnetostrictive material is exposed to an alternating magnetic field, it starts to vibrate. This external time-varying magnetic field can be a time-harmonic signal or a non-uniform field pulse (or several such pulses transmitted randomly or periodically). A magnetostrictive electroplating employed in connection with a filter structure of the invention—such as that labeled 83e in FIG. 8D, 93e-a in FIG. 9A, and more-preferably due to ease of fabrication, the electroplating at 93e-b, FIG. 9A—can operate as an ON-OFF switch as follows: Applying a time-varying magnetic field to the environment in which the filter has been placed will cause the magnetostrictive layer/coating to vibrate, thus affecting diffusion characteristics of the membrane; see also method 110, FIG. 11 especially steps 284 and 290. With proper selection of pore size as dependent upon application, without an applied time-varying magnetic field the substance does not diffuse through the porous membrane, effectively turning OFF the diffusion capability of the filter. Alternatively, when the external field is applied the capsule vibrates, promoting diffusion, and thereby effectively turning the filter back ON.

In the event the filter structure is adapted for use as a hydrogen reactor the electrodeposition is preferably platinum or other suitable catalyst material (step 184, FIG. 100) that aids in the production of hydrogen gas. By way of example, methane gas in the presence of a platinum electroplating catalyst splits methane (in a reaction that takes place at approximately 300 degrees-C) into hydrogen and residuals. An interior inner wall surface of a filter structure of the invention to which a suitable catalyst material has been deposited (see FIG. 8D at 83e and FIG. 9A at 93e-a) may be employed as a hydrogen reactor as follows: The first layer of pores of the membrane are sized small enough to permit hydrogen produced in within the reactor 81d to diffuse out at a certain rate, yet filter-out larger unwanted molecules and particles from entering through the two-layer membrane (88c, 88d in FIGS. 8C and 8D).

FIG. 10 is a flow diagram depicting details of a method 100 for producing nanoporous filter structures—including core, as well as further distinguishing features for producing structures such as those depicted in FIGS. 8A-8D and 9A. FIG. 11 is a flow diagram depicting details of a method 110 for producing nanoporous filter structures—including core features for producing structures such as those depicted in FIG. 9B. Reference and discussion has been made throughout this disclosure of the novel steps of methods at 100 and 110, in connection with other figures.

### EXAMPLE 1.

A mechanically robust nanoporous alumina capsule was produced by way of example only, with a generally uniform two-layer branched network of pores ranging from 25 nm to 55 nm. Characterization of diffusion from the nanoporous capsules using fluorescein isothiocyanate and dextran conjugates of varying molecular weight, allowed molecular transport which may be controlled by selection of capsule pore size. The layer of smaller sized pores effectively prevented large molecules from diffusing, for use of the filter structure as a biocapsule for immunoisolation applications. Pore diameter of the alumina films was controlled via the anodizing voltage, with a pore size to anodizing voltage relationship of 1.29 nm/V. The membranes can be fabricated in a few hours, from aluminum metal allowing for lower-cost, large-scale fabrication into devices for filtration of fluids (gas and liquid phase) such as biofiltration and gas separation.

Here, tubular AAO membranes were made from aluminum alloy (Al_{98 6} Mn_{1 2} CU_{0.12}) pipe purchased from Alfa Aesar, using a two-step anodization process (steps 76 and 78)—an improvement in pore size uniformity over a single-step anodization. The length, outer-diameter, and thickness of the starting tubes were, respectively, 3.5 cm, 6.35 mm and 700 μm. After the tube was cleaned using an acetone ultrasonic bath, it was initially anodized in oxalic acid for several minutes to form a thin layer, less than 100 nm, of alumina on the outer surface of the tube (aiding in adhesion of the subsequently applied polymer used to protect the outer surface of the tube during subsequent anodization steps). Any suitable polymer or other material may be used.

The first anodization step (step 76) was performed in 0.2 M˜0.3 M oxalic acid for 15 hours at the desired voltage (˜25 to 100 V) to produce an AAO layer (˜50 to 100 μm thick) that had formed on the interior of the tube. The tubing was then etched in a 4% wt chromic acid and 8% volume phosphoric acid mixture to remove this thin initial layer. Thus, a uniform nano-concave foundation/array was created, helpful for achieving the selected pore size distribution during subsequent anodization to produce the membrane. With the exterior of the tube still protected by the polymer film, a second anodization (step 78) was conducted from the inner wall of the tubing, applying approximately the same voltage as used in the first anodization. If only one voltage is applied, a network similar to that depicted in FIGS. 3A-3B will be produced. If a two-step voltage process is used, a network such as that at 60 in FIG. 6 will be produced. The duration of the anodizing period controls the membrane (18d-f) thickness. For Example 1, the duration of the second anodization was ˜11 to 18 hours with a total charge supplied from the power source of approximately 1200 Coulomb for the 3.5 cm long metal tube samples.

A window-area in the polymer film protecting the outer-surface was then removed, and the tube ends capped with parafilm. The tube was then dipped in a 10%wt HCl and 0.1 M CuCl₂ solution (or the more hazardous HgCl₂) to remove ‘unprotected’ aluminum (Al-Mn) outer wall of the window, exposing an area of the AAO membrane (at 31 in FIGS. 3A-3B). The AAO membranes produced were ˜100 ±10 μm. To remove the barrier layer at the outer surface of the AAO membrane, the tube was further etched in 4% wt chromic and 8% volume phosphoric acid mixture for ten minutes at room temperature (FIG. 1D). Then the parafilm endcaps (e.g., of silicone or TEFLON® and protecting polymer layer were removed (FIG. 1E). The described fabrication technique is applicable to any length or size tube as needed to provide a structure with suitable mechanical strength.

### EXPERIMENTAL RESULTS (EXAMPLE—DIFFUSION).

In the case of use for bio-filtration, release experiments consisted of monitoring the diffusion of fluorescein isothiocyanate (FITC) of varying molecular weight as a function of time after encapsulation within the alumina tubes. Model drug molecules used in this work included FITC and FITC-dextran conjugates of various molecular weights. Stock solutions of all fluorophores were prepared in 0.1 M phosphate buffered saline at a concentration of 2.5 mg/ml. The porous alumina capsules were filled with stock solution of FITC or FITC-dextran at a concentration of 2.5 mg/ml and then sealed. These capsules were then immersed in 0.1 M PBS with continuous stirring and well-mixed conditions maintained on the outside. The fluorescence of the PBS solution was measured at regular time intervals. Values of the fluorescent signal peaks (λ_{cm}=520 nm, (λ_{cx}=490 nm) were converted to the corresponding concentrations using a calibration curve. The release experiments were repeated with capsules of different pore size to examine molecule release as a function of the pore diameters. The values were then further normalized to membrane surface area to facilitate sample comparison. Increasing the pore size from 25 to 55 nm increases the release rate; the results demonstrate how pore size can be selected to achieve a desired release rate. The release behavior demonstrates Fickian-like diffusion observed with porous-polymer films.

To achieve small pore size while maintaining a physically robust membrane, the anodization is preferably done at two different voltages, as detailed herein, reduced in a step-wise fashion resulting in a subdivision of the pore into smaller branches. For example, the higher voltage may be selected from a range of ˜25V to 100V and applied for a period of several to many hours (e.g., 11-20 hrs), and then stepped down (taking, for example, a transition time of 10 minutes) to a lower voltage selected from a range of ˜5V to 25V applied for a shorter time period, e.g., 1 to 2 hours, creating a thinner layer. The larger pore-sized region provides a robust support to the thinner layer of desired small pore size. While, preferably, the larger sized pores are internal, or near the inner wall (of receptacle formed at 11d-f of FIGS. 1D-1F) with respect to the layer of smaller sized pores, this is not a critical requirement. The layer orientation within the network of pores may be reversed if that better accommodates the application to which the filter structure will be used. The relatively thin small-pore region largely determines the filter characteristics of the resultant membrane. Several advantages are achieved with the branched membranes. The mechanical support provided by the larger pore-size layer enables an otherwise improbable AAO filter layer pore size to be achieved of ≦10 nm. Furthermore, the small pore layer may be made very thin, <1 μm, resulting in a membrane sufficient to deter transport of larger immunological molecules while at the same time increasing the diffusion efficiency out of a capsule structure of small nutrition molecules. Moreover, since most unwanted residuals will be trapped at the surface layer (exposed areas such as those at 21d/21f of FIGS. 1D and 1F, and at 31 of FIG. 3A-3B) the branched structure facilitates cleaning of the filter structures.

While certain representative embodiments and details have been shown for the purpose of illustrating the invention, those skilled in the art will readily appreciate that various modifications, whether specifically or expressly identified herein, may be made to these representative embodiments without departing from the novel teachings or scope of this technical disclosure. Accordingly, all such modifications are intended to be included within the scope of the claims. Although the commonly employed preamble phrase “comprising the steps of” may be used herein, or hereafter, in a method claim, the Applicants do not intend to invoke 35 U.S.C. §112 ¶6. Furthermore, in any claim that is filed herewith or hereafter, any means-plus-function clauses used, or later found to be present, are intended to cover at least all structure(s) described herein as performing the recited function and not only structural equivalents but also equivalent structures.

What is claimed is:

1. A nanoporous tubular filter comprising:
a membrane comprising a network of generally branched pores formed by anodization of a section of metal tubing, said network extending from an inner wall of the filter to and through an outer exposed wall area of said membrane, said network having a first layer of pores with a diameter greater than that of pores of an adjacent second layer; and
said network integral with an outer support matrix having been formed of an outer wall of said section of tubing by removing selected portions of said outer wall to provide said exposed wall area of said membrane.

2. The nanoporous tubular filter of claim 1 wherein said outer support matrix corresponds with a patterned area formed of an external-coat applied to said outer wall; and once said selected portions of said outer wall are so removed, said patterned area is removed exposing said outer support matrix.

3. The nanoporous tubular filter of claim 2 wherein said external-coat is applied to an exterior surface of said outer wall prior to said anodization forming said network, said anodization is performed using a first and second voltage, and said patterned area comprises residual portions of said external-coat left after removal of surrounding material once said network has been formed.

4. The nanoporous tubular filter of claim 2 wherein: an initial external-coat is applied to an exterior surface of said outer wall prior to said anodization forming said network; said anodization is performed using a first and second voltage; and once said network has been formed, said initial external-coat is removed and said patterned area is so applied by stenciling said external-coat material to said outer wall.

5. The nanoporous tubular filter of claim 2 wherein: said membrane is made of alumina; said outer support matrix comprises aluminum; said exposed wall area comprises a patterning selected from the group consisting of a window-pattern, a spiral, striping, a zig-zag pattern, a plurality of alternating rings, and an irregular design; and said anodization is performed using a first and second voltage, said first layer of pores having been formed at said first voltage prior to said second layer of pores formed at said second voltage, said first voltage being greater than said second voltage.

6. The nanoporous tubular filter of claim 2 further comprising an electroplating of a magnetostrictive material deposited on said exposed outer support matrix adapted for use as a diffusion ON-OFF switch of a substance permeable to said membrane, whereby application of a time-varying magnetic field to the filter alters a rate of diffusion of said substance through said membrane.

7. The nanoporous tubular filter of claim 1 wherein said outer support matrix corresponds with a patterned area formed of an external-coat applied to said outer wall; and further comprising an electroplating of a magnetostrictive material deposited on exposed-metal portions of an interior surface of said inner wall of the filter adapted for use as a diffusion ON-OFF switch of a substance permeable to said membrane, whereby application of a time-varying magnetic field to the filter alters a rate of diffusion of said substance through said membrane.

8. The nanoporous tubular filter of claim 1 further comprising a cap at each end thereof, a capsule formed thereby adapted to contain a substance permeable to said membrane; and wherein said first layer of pores is internal with respect to said second layer, and said diameter of said second layer pores is less than a diameter of a selected molecule type.

9. The nanoporous tubular filter of claim 1 adapted for use as a hydrogen reactor wherein a substance produced within said inner wall of the filter and permeable to said membrane comprises hydrogen; and further comprising an electroplating of a catalyst material deposited on at least a portion of said inner wall of the filter.

10. The nanoporous tubular filter of claim 8 adapted for in vivo use, and wherein: said membrane is made of alumina; said outer support matrix comprises aluminum; said substance is a nutrient; said second layer of said membrane is generally impermeable to said selected molecule type which comprises an immunological molecule.

11. The nanoporous tubular filter of claim 1 wherein: a cross-section of said inner wall of the filter has an inner surface perimeter selected from the group consisting of a circle, an oval, a polygon, and an irregular shape; said membrane has a thickness of approximately 100 microns; said diameter of said first layer of pores ranges from 40 to 200 nanometers; a thickness of said second layer pores is less than 15 microns and said diameter of said second layer pores ranges from 5 to 40 nanometers; and said exposed wall area comprises a patterning selected from the group consisting of a window-pattern, a spiral, striping, a zig-zag pattern, a plurality of alternating rings, and an irregular design.

12. The nanoporous tubular filter of claim 1 wherein said second layer of pores is internal with respect to said first layer, and said second layer of pores is generally impermeable to a preselected molecule type; and said anodization is performed using a first and second voltage, said second layer of pores having been formed at said second voltage prior to said first layer of pores formed at said first voltage, said first voltage being greater than said second voltage.

13. A method for producing a nanoporous tubular filter, the method comprising the steps of:
applying an external-coat to an exterior surface of an outer wall of a section of metal tubing;
anodizing said section of tubing at a first voltage for a first time-period then at a second voltage for a second time-period, a membrane produced thereby comprising a network of generally branched pores extending from an inner wall of said section of tubing to and through an exposed wall area of said membrane, said network having a first layer of pores with a size different from that of pores of an adjacent second layer; and
forming a patterned area to cover that portion of said outer wall that will form an outer support matrix.

14. The method of claim 13 further comprising the steps of:
temporarily capping each of an end of said section of tubing to seal off said inner wall;
removing portions of said outer wall around said patterned area to provide said exposed wall area of said membrane by placing said section of tubing into an acid mixture, forming said outer support matrix; and
removing said patterned area to expose said outer support matrix.

15. The method of claim 13 wherein said step of forming a patterned area comprises removing surrounding material of said external-coat, leaving residual portions thereof; and further comprising the steps of:
removing portions of said outer wall around said patterned area to provide said exposed wall area of said membrane, forming said outer support matrix; and
removing said patterned area to expose said outer support matrix.

16. The method of claim 13 further comprising, after said membrane is produced, the step of removing said external-coat; and wherein said step of forming a patterned area further comprises stenciling a second external-coat to said outer wall to form said patterned area, and said step of anodizing said section of tubing at a first voltage then at a second voltage, comprises applying said first voltage selected from a first range of values then applying said second voltage selected from a second range of values, said first range being greater than said second range.

17. The method of claim 13 wherein said step of anodizing said section of tubing at a first voltage then at a second voltage, comprises applying said first voltage selected from a first range from 25V to 100V then applying said second voltage selected from a second range from 5V to 25V such that said membrane produced comprises alumina, said first layer of pores internal with respect to said second layer; and further comprising the step of, prior to said step of applying said external-coat, anodizing said section of tubing, comprising aluminum, to form a thin porous alumina layer on an exterior surface of said outer wall.

18. The method of claim 17 further comprising, after said step of applying an external-coat, the steps of: anodizing said section of tubing creating an initial alumina film on an interior surface of said inner wall, said alumina film comprising a plurality of pores having a diameter generally equal to said size of said first layer of pores; then removing a substantial portion of said initial alumina film by placing said section of tubing into an acid mixture.

19. The method of claim 18 further comprising the step of capping each end of said section of tubing to form a capsule adapted for in vivo use such that said second layer of pores is generally impermeable to an inmnunological molecule; and wherein said step of anodizing said section of tubing creating said initial alumina film on said interior surface comprises applying a voltage selected from an initial range of 25V to 100V to create said film having a thickness from 5 to 200 microns.

20. The method of claim 13 further comprising the steps of:
removing portions of said outer wall around said patterned area to provide said exposed wall area of said membrane, forming said outer support matrix;
removing said patterned area to expose said outer support matrix:
electroplating a magnetostrictive material deposit onto said exposed outer support matrix, said deposited material adapted for use as a diffusion ON-OFF switch of a substance permeable to said membrane, whereby applying a time-varying magnetic field to the filter alters a rate of diffusion of said substance through said membrane.

21. The method of claim 13 further comprising, prior to producing said membrane, the step of applying an internal-coat to portions of an interior surface of said inner wall of said tubing; and after said step of forming said patterned area, the steps of:
removing said internal-coat so applied to expose metal portions of said interior surface; and
electroplating a magnetostrictive material deposit onto said exposed metal portions adapted for use as a diffusion ON-OFF switch of a substance permeable to said membrane, whereby applying a time-varying magnetic field to the filter alters a rate of diffusion of said substance through said membrane.

22. The method of claim 13 wherein the filter is adapted for use as a hydrogen reactor and further comprising the steps of: electroplating a catalyst material deposit onto at least a portion of said inner wall of said tubing such that a substance produced therewithin, and permeable to said membrane, comprises hydrogen.

23. The method of claim 13 wherein said section of tubing comprises aluminum; and said step of anodizing said section of tubing at a first voltage for a first time-period then at a second voltage for a second time-period, comprises applying said first voltage selected from a first range of values then applying said second voltage selected from a second range of values, said first range being greater than said second range, and said membrane produced comprises alumina with said first layer of pores internal with respect to said adjacent second layer.

24. The method of claim 23:
wherein said first range of values inclusively comprises 25V to 100V, said second range of values inclusively comprises 5V to 25V, said second time-period is at least an hour, said membrane is produced having a thickness of approximately 100 microns, said size of said first layer of pores ranges from 40 to 200 nanometers, a thickness of said second layer pores is less than 15 microns and said size of said second layer pores ranges from 5 to 40 nanometers; and
further comprising, after said step of applying an external-coat, the steps of anodizing said section of tubing creating an initial film on an interior surface of said inner wall, then removing a substantial portion of said initial film.

25. A method for producing a nanoporous tubular filter, the method comprising the steps of:
anodizing a section of metal tubing to form a thin porous layer on an exterior surface of an outer wall of said section;
applying an external-coat to said exterior surface;
anodizing said section of tubing creating an initial porous film on an interior surface of an inner wall of said section, then removing a substantial portion of said initial porous film;
anodizing said section of tubing at a first voltage for a first time-period then at a second voltage for a second time-period, a membrane produced thereby comprising a network of generally branched pores extending from said inner wall to and through an exposed wall area of said membrane, said network having a first layer of pores with a size greater than that of pores of an adjacent second layer; and
forming a patterned area to cover that portion of said outer wall that will form an outer support matrix.

26. The method of claim 25: wherein said step of applying said external-coat comprises adhering a coating of polymer to said exterior surface; and said step of anodizing said section of tubing creating an initial porous film comprises applying a voltage selected from a range of 25V to 100V to create said film having a thickness from 5 microns to 200 microns; and further comprising the steps of:
removing portions of said outer wall around said patterned area to provide said exposed wall area of said membrane, forming said outer support matrix;
temporarily capping each of an end of said section of tubing to seal off said inner wall from exposure to an agent used during said step of forming said outer support matrix; and
removing said patterned area to expose said outer support matrix.

27. The method of claim 25 wherein: said section of tubing comprises aluminum; said step of forming a patterned area comprises removing surrounding material of said external-coat, leaving residual portions thereof; said step of anodizing said section of tubing at a first voltage then at a second voltage, comprises applying said first voltage selected from a first range of values then applying said second voltage selected from a second range of values, said first range being greater than said second range.

28. The method of claim 25:
further comprising, after said membrane is produced, the step of removing said external-coat; and the step of capping each end of said section of tubing to form a capsule adapted for in vivo use such that said second layer of pores is generally impermeable to a selected molecule type; and
wherein said section of tubing comprises aluminum, and said step of forming a patterned area further comprises stenciling a second external-coat to said outer wall to form said patterned area.
